(19) United States
(12) Patent Application Publication
(10) Pub. No.: US 2005/0088569 A1
(43) Pub. Date: Apr. 28, 2005

(54) EXTERNAL STROBE DEVICE

(76) Inventors: Yu-Bang Fu, Tao-Yuan Hsien (TW); Yu-Chia Lin, Hsin-Chu City (TW); Che-Wei Chen, Taipei Hsien (TW); Tai-Ying Wu, Taipei City (TW)

Correspondence Address: NORTH AMERICA INTERNATIONAL PATENT OFFICE (NAIPC), P.O. BOX 506, MERRIFIELD, VA, 22116, US

(21) Appl. No.: 10/708,154

(22) Filed: Feb. 12, 2004

(30) Foreign Application Priority Data
Oct. 22, 2003 (TW) 092129348

(51) Int. Cl. H04N 5/222

(52) U.S. Cl. 348/371

(57) ABSTRACT

An external strobe device for connecting to an image-capturing apparatus. The image capturing apparatus includes a housing, a second electrical port, and a first signal port. The external strobe device includes a housing, a strobe module, a battery module, a first electrical port for connecting to the second electrical port and transmitting electric power produced by the battery module to the second electrical port to supply the electric power of the image-capturing apparatus, and a transformer for transforming an output voltage of the battery module into a standard voltage of the strobe module and into the standard voltage of the image-capturing apparatus.

### BACKGROUND OF INVENTION

1. Field of the Invention

The present invention relates to an external strobe device for connecting to an image-capturing apparatus, and more specifically, to an external strobe device for supplying the operating electric power of the image-capturing apparatus.

2. Description of the Prior Art

Cameras are popular tools for recording events in amateur and professional fields. Cameras using traditional films and digital cameras are widely used and are low-cost. And cameras are currently following a trend of having small size, light weight, and low power consumption. The power consumption is the main consideration especially for an electric viewfinder of a digital camera.

During the photographing process sometimes there are little light around the capturing body. At this time a photographer has to utilize the fill light to increase the luminance of the capturing body. And the most popular auxiliary light source is a strobe. Most strobes are very light, low-cost, and with large luminous power. And strobes almost can handle the quality, quantity, and direction of light. The artificial light source can substitute the natural light absolutely and be controllable. The difference between the strobe and other light source is that the strobe twinkles suddenly but the luminosity and the shining time is very short.

The working principle of strobes is utilizing high-voltage current to discharge electricity in a tube filled with Xe and producing a transient and vivid flash. Because the strobe shines by discharging electricity instead of heating a filament, the operational lifetime is high and the strobe can be used a great many times. The function of the strobe develops from the manual adjustment to the photoelectric cell sensitization and TTL automatic exposure. In addition, there are many auxiliaries, like a swingable lamb receptacle, a segregating electric eye, a zoom lens flash, variable outputting power, LED and acoustic display, and so on.

There are two kinds of strobes, a built-in strobe and an external strobe. The built-in strobe in a camera usually shines the light to the capturing body directly, so an ugly shadow might occur. In this condition, the external strobe is proposed. Besides, the external strobe provides many manual optional functions, such as adjusting the luminance, flash times and frequency, and can avoid shadows and redeye effect produced by the built-in strobes.

However the conventional external strobe consumes more electric power, so it has to receive the external electric power independent of the power supply of an image-capturing device to avoid increasing the electric load of the image-capturing device. However the power supply of the external strobe can afford the operating electric power of the external strobe so it can be a solution to the electric problem of an image-capturing apparatus.

### SUMMARY OF INVENTION

It is therefore a primary objective of the present invention to provide an external strobe device for connecting to an image-capturing apparatus to solve the problems mentioned above.

Briefly summarized, an external strobe device for connecting to an image-capturing apparatus is proposed. The image-capturing apparatus comprises a housing and a transmission module installed inside the housing. The external strobe device comprises a housing, a strobe module installed inside the housing for providing light when the image-capturing apparatus captures an image, a battery module installed inside the housing for supplying operating electric power of the strobe module, a first electric port for connecting to the transmission module of the image-capturing apparatus and transmitting the electric power produced by the battery module to the transmission module to supply the operating electric power of the image-capturing apparatus, and a transformer installed inside the housing and electrically connected to the battery module, the strobe module, and the first electric port for transforming an outputting voltage of the battery module into a standard voltage of the strobe module and outputting the standard voltage of the strobe module to the strobe module, and for transforming the outputting voltage of the battery module into the standard voltage of the image-capturing apparatus and outputting the standard voltage of the image-capturing apparatus to the image-capturing apparatus via the first electric port.

Briefly summarized, an external image-capturing device for connecting to a mobile phone is proposed. The mobile phone comprises a first electric port for receiving external electric power to supply the operating electric power of the mobile phone and a first signal port for transmitting signals to the external image-capturing device to control the external image-capturing device. The external image-capturing device comprises a housing, a phone camera module for capturing an image, a strobe module installed inside the housing for providing light when the phone camera module captures an image, a battery module installed inside the housing for supplying the operating electric power of the external image-capturing device, a second electric port for connecting to the first electric port of the mobile phone and transmitting the electric power produced by the battery module to the first electric port of the mobile phone to supply the operating electric power of the mobile phone, and a transformer installed inside the housing and electrically connected to the battery module, the phone camera module, the strobe module, and the second electric port for transforming an outputting voltage of the battery module into a standard voltage of the strobe module and outputting the standard voltage of the strobe module to the strobe module, transforming the outputting voltage of the battery module into the standard voltage of the phone camera module and outputting the standard voltage of the phone camera module to the phone camera module, and for transforming the outputting voltage of the battery module into the standard voltage of the mobile phone and outputting the standard voltage of the mobile phone to the mobile phone via the second electric port.

These and other objectives of the present invention will no doubt become obvious to those of ordinary skill in the art after reading the following detailed description of the preferred embodiment that is illustrated in the various figures and drawings.

### BRIEF DESCRIPTION OF DRAWINGS

FIG. 1 is a top view of an external strobe device connected to an image-capturing apparatus of the first embodiment according to the present invention.

FIG. 2 is a bottom view of the external strobe device connected to the image-capturing apparatus according to the present invention.

FIG. 3 is a detailed diagram of the connection part between the external strobe device and the image-capturing apparatus.

FIG. 4 is a block diagram of the external strobe device connected to the image-capturing apparatus.

FIG. 5 contains a flowchart illustrating actions after the external strobe device is connected to the image-capturing apparatus of the first embodiment according to the present invention.

FIG. 6 is a diagram of an external image-capturing device connected to a mobile phone of the second embodiment according to the present invention.

FIG. 7 is a block diagram of the external image-capturing device connected to the mobile phone.

FIG. 8 contains a flowchart illustrating actions after the external image-capturing device is connected to the mobile phone of the second embodiment according to the present invention.

### DETAILED DESCRIPTION

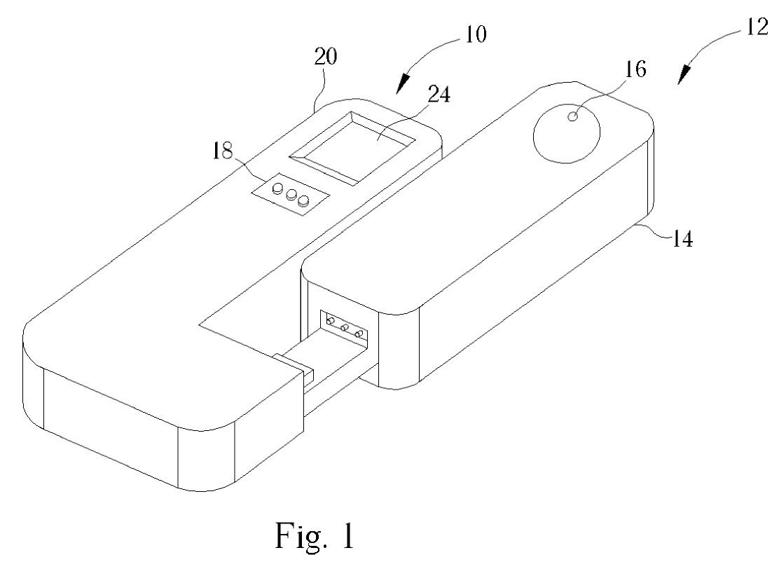

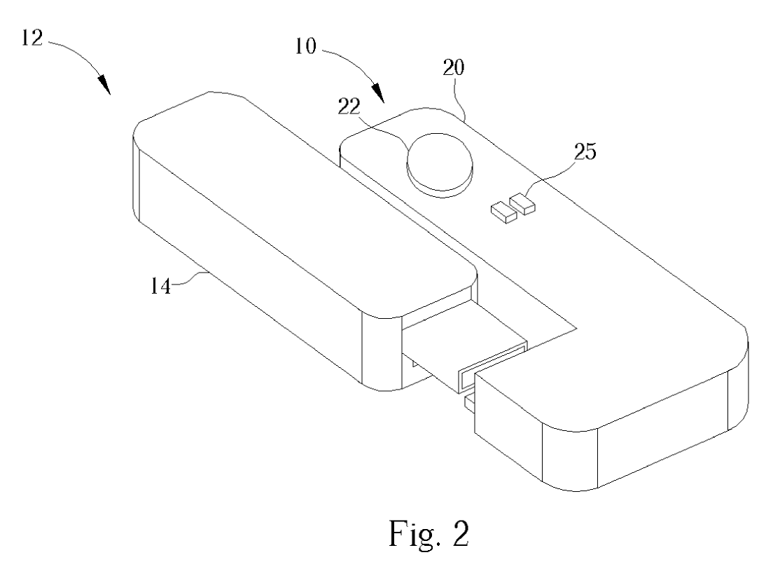

Please refer to FIG. 1 and FIG. 2. FIG. 1 is a top view of an external strobe device 10 connected to an image-capturing apparatus 12 of the first embodiment according to the present invention. FIG. 2 is a bottom view of the external strobe device 10 connected to the image-capturing apparatus 12 according to the present invention. The image-capturing apparatus 12 can be a digital camera. The image-capturing apparatus 12 includes a housing 14 and a lens 16 for capturing an image. The external strobe device 10 includes a strobe switch 18. Users can operate the strobe switch 18 to choose the auto-detecting mode, forced-flashing mode, and non-flashing mode. The external strobe device 10 further includes a housing 20, a power switch 22 for turning on or turning off the external strobe device 10, the strobe module 24 installed inside the housing 20 for providing light when the image-capturing apparatus 12 captures an image, and an electric light 25 for providing the electric condition of the external strobe device 10.

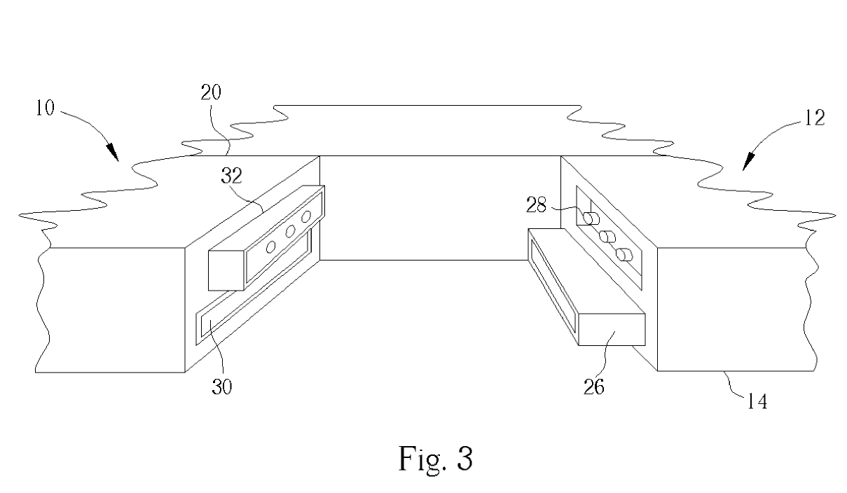

Please refer to FIG. 3. FIG. 3 is a detailed diagram of the connection part between the external strobe device 10 and the image-capturing apparatus 12. The transmission module 23 installed inside the housing 14 includes a second electric port 26 for receiving the external electric power to supply the operating electric power of the image-capturing apparatus 12, and a first signal port 28 for transmitting signals to the external strobe device 10 to operate the external strobe device 10. The external strobe device 10 further includes a first electric port 30 installed on the housing 20 for connecting to the second electric port 26 of the image-capturing apparatus 12 and transmitting the electric power of the external strobe device 10 to the second electric port 26 to supply the operating electric power of the image-capturing apparatus 12, a second signal port 32 installed on the housing 20 for connecting the first signal port 28 and receiving signals from the image-capturing apparatus 12. The signal transmission between the first signal port 28 and the second signal port 32 can utilize an I2C or a UART interface.

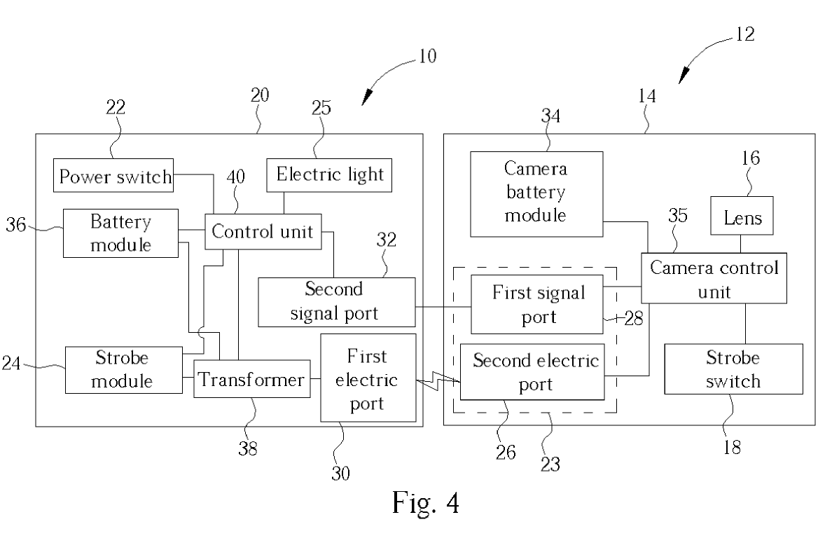

Please refer to FIG. 4. FIG. 4 is a block diagram of the external strobe device 10 connected to the image-capturing apparatus 12. The image-capturing apparatus 12 further includes a camera battery module 34 installed inside the housing 14 of the image-capturing apparatus 12 for supplying the operating electric power of the image-capturing apparatus 12, and a camera control unit 35 for controlling the image-capturing apparatus 12. The external strobe device 10 further includes a battery module 36 installed inside the housing 20 for supplying the operating electric power of the strobe module 24. The battery module 36 can contain a 3-volt Cr2 battery, two Ni-MH batteries, or two Li-On batteries. The external strobe device 10 can provide more electric power than the electric power provided by the image-capturing apparatus 12 and the electric power consumption of the image-capturing apparatus 12. The external strobe device 10 further includes a transformer 38 installed inside the housing 20 and electrically connected to the battery module 36, the strobe module 24, and the first electric port 30 for transforming the outputting voltage of the battery module 36 into the standard voltage of the strobe module 24 and outputting the standard voltage of the strobe module 24 to the strobe module 24, and for transforming the outputting voltage of the battery module 36 into the standard voltage of the image-capturing apparatus 12 and outputting the standard voltage of the image-capturing apparatus 12 to the image-capturing apparatus 12 via the first electric port 30. The standard voltage of the image-capturing apparatus 12 transformed from the outputting voltage of the battery module 36 can be 5 volts. The external strobe device 10 further includes a control unit 40 installed inside the housing 20 and electrically connected to the power switch 22, the strobe module 24, the second signal port 32, the battery module 36, and the transformer 38 for controlling the external strobe device 10.

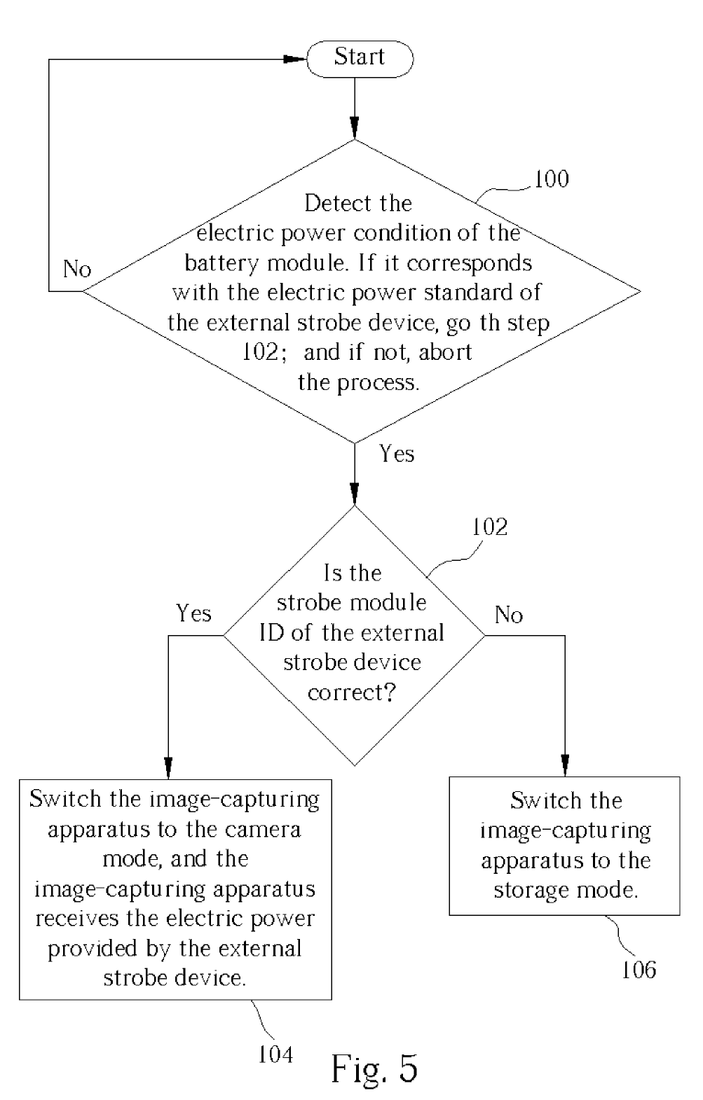

Please refer to FIG. 5. FIG. 5contains a flowchart illustrating actions after the external strobe device 10 is connected to the image-capturing apparatus 12 of the first embodiment according to the present invention. The method includes: Step 100: detect the electric power condition of the battery module 36 of the external strobe device 10. If the electric power condition corresponds with the electric power standard of the external strobe device 10, go to Step 102; and if not, abort the process;Step 102: the image-capturing apparatus 12 obtains the strobe module ID of the external strobe device 10. If the strobe module ID of the external strobe device 10 is correct, go to Step 104; and if not, go to Step 106; Step 104: switch the image-capturing apparatus 12 to the camera mode. And the image-capturing apparatus 12 receives the electric power provided by the external strobe device 10; and Step 106: switch the image-capturing apparatus 12 to the storage mode.

The detailed description of the actions listed above is as follows. After the external strobe device 10 is connected to the image-capturing apparatus 12, the control unit 40 has to detect whether the electric power condition of the battery module 36 of the external strobe device 10 corresponds with the electric power standard of the external strobe device 10. If the electric power condition corresponds with the electric power standard of the external strobe device 10, the control unit 40 of the external strobe device 10 sends a corresponding signal to the first signal port 28 of the image-capturing apparatus 12 via the second signal port 32 to inform the camera control unit 35 that the electric power condition is correct. The image-capturing apparatus 12 also sends back an acknowledgment signal to the external strobe device 10. If the electric power condition does not correspond with the electric power standard of the external strobe device 10, the external strobe device 10 will abort the operating process.

If the electric power condition of the battery module 36 corresponds with the electric power standard of the external strobe device 10, the control unit 40 of the external strobe device 10 will send the strobe module ID to the first signal port 28 of the image-capturing apparatus 12 via the second signal port 32 and then to the camera control unit 35. If the type specification of the external strobe device 10 is suitable for the image-capturing apparatus 12, the image-capturing apparatus 12 will send back an acknowledgment signal to the external strobe device 10 and the camera control unit 35 will switch the image-capturing apparatus 12 to the camera mode. And then users can use the image-capturing apparatus 12 to capture an image. And at the same time, the transformer 38 will transform the outputting voltage of the battery module 36 into the standard voltage of the image-capturing apparatus 12 and output the standard voltage of the image-capturing apparatus 12 to the second electric port 26 of the image-capturing apparatus 12 via the first electric port 30 for providing the operating electric power of the image-capturing device 12. The electric transmission between the first electric port 30 and the second electric port 26 can use a USB interface. That is, when the image-capturing apparatus 12 captures an image, the image-capturing apparatus 12 uses the electric power provided by the battery module 36 of the external strobe module 10 instead of the camera battery module 34. In addition, when the image-capturing apparatus 12 does not capture an image but is still connected to the external strobe device 10, the battery module 36 of the external strobe module 10 also can charge the camera battery module 34 of the image-capturing apparatus 12 via the connection between the first electric port 30 and the second electric port 26. Therefore if the external strobe device 10 is disconnected from the image-capturing apparatus 12, the image-capturing apparatus 12 can use the electric power charged previously. The image-capturing apparatus 12 can be designed such that users can decide to use the electric power from the camera battery module 34 of the image-capturing apparatus 12 or the battery module 36 of the external strobe device 10. If the type specification of the external strobe device 10 is not suitable for the image-capturing apparatus 12, the camera control unit 35 will switch the image-capturing apparatus 12 to the storage mode instead of the camera mode. It is because the image-capturing apparatus 12 can not drive the external strobe device 10 correctly. The image-capturing apparatus 12 can include a storage module for storing capturing images, and it also can be a storage medium for transmitting data with a computer.

Users can operate the strobe switch 18 to choose the auto-detecting mode, forced-flashing mode, and non-flashing mode. When the external strobe device 10 is used to provide the light during the image-capturing process, the camera control unit 35 of the image-capturing apparatus 12 will generate a driving signal and send it to the second signal port 32 via the first signal port 28 and then to the control unit 40 of the external strobe device 10 for driving the strobe module 24 to flash. The control unit 40 of the external strobe device 10 can monitor the electric power condition of the battery module 36 anytime and send the electric power condition of the battery module 36 to the first signal port 28 via the second signal port 32 and then to the camera control unit 35 of the image-capturing apparatus 12. In this way, users can realize the remaining electric power quantity.

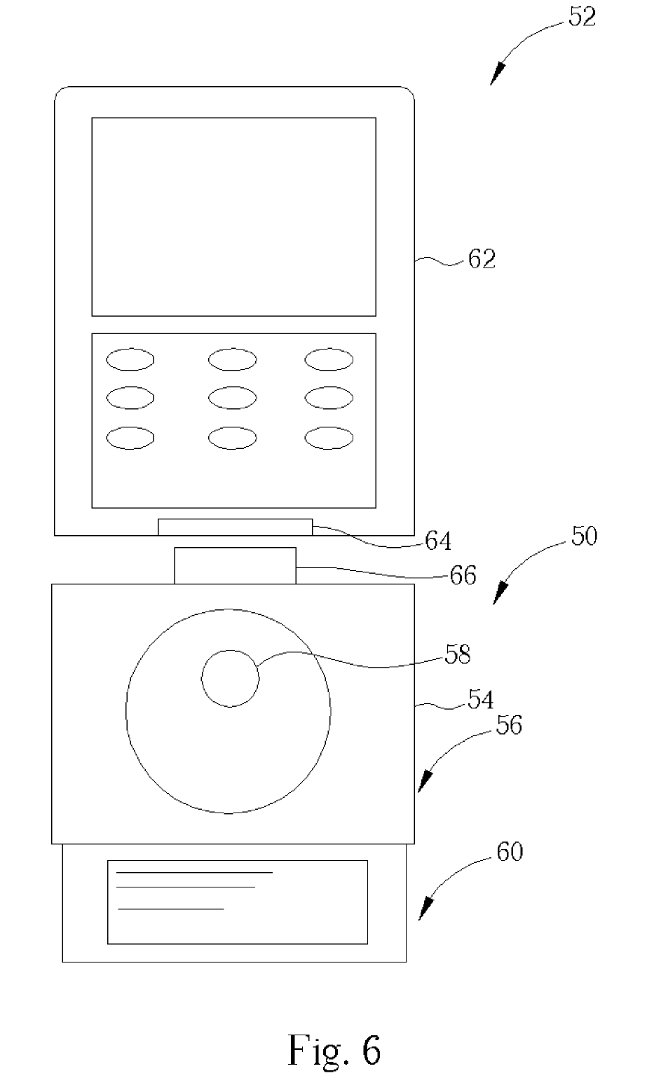

The present invention can be applied to an external image-capturing device for connecting to a mobile phone. Please refer to FIG. 6. FIG. 6 is a diagram of an external image-capturing device 50 connected to a mobile phone 52 of the second embodiment according to the present invention. The external image-capturing device 50 includes a housing 54, a phone camera module 56 including a lens 58 for capturing an image, and a strobe module 60 installed inside the housing 54 for providing light when the phone camera module 56 captures an image. The mobile phone 52 includes a housing 62, a first transmit port 64 installed on the housing 62. The external image-capturing device 50 further includes a second transmit port 66 installed on the housing 54 for connecting to the first signal port 64 of the mobile phone 52.

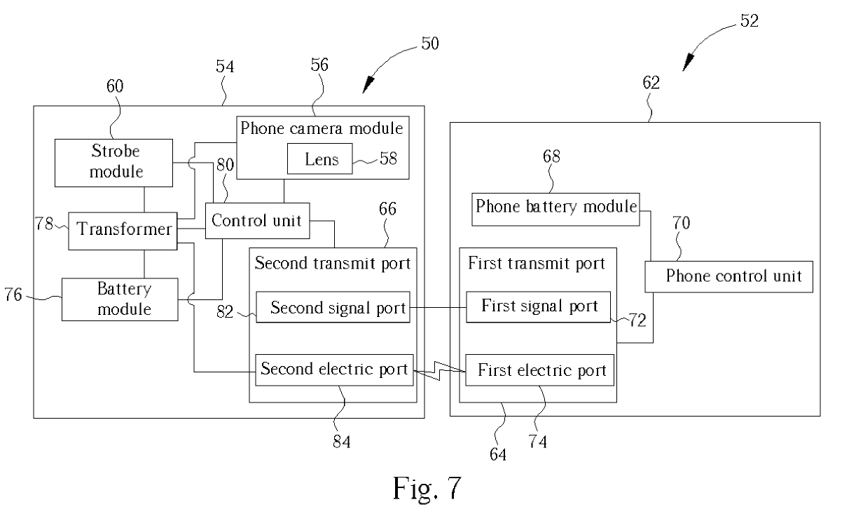

Please refer to FIG. 7. FIG. 7 is a block diagram of the external image-capturing device 50 connected to the mobile phone 52. The mobile phone further includes a phone battery module 68 installed inside the housing 62 of the mobile phone 52 for supplying the operating electric power of the mobile phone 52, and a phone control unit 70 for controlling the mobile phone 52. The first transmit port 64 includes a first signal port 72 for transmitting signals to the external image-capturing device 50 to control the external image-capturing device 50 and a first electric port 74 for receiving the external electric power to supply the operating electric power of the mobile phone 52. The external image-capturing device 50 further includes a battery module 76 installed inside the housing 54 for supplying the operating electric power of the external image-capturing device 50. The battery module 76 can contain a 3-volt Cr2 battery, two Ni-MH batteries, or two Li-On batteries. The external image-capturing device 50 further includes a transformer 78 installed inside the housing 54 and electrically connected to the battery module 76, the strobe module 60, and the second electric port 66 for transforming the outputting voltage of the battery module 76 into the standard voltage of the strobe module 60 and outputting the standard voltage of the strobe module 60 to the strobe module 60, transforming the outputting voltage of the battery module 76 into the standard voltage of the phone camera module 56 and outputting the standard voltage of the phone camera module 56 to the phone camera module 56, and for transforming the outputting voltage of the battery module 76 into the standard voltage of the mobile phone 52 and outputting the standard voltage of the mobile phone 52 to the mobile phone 52 via the second electric port 66. The standard voltage of the mobile phone 52 transformed from the outputting voltage of the battery module 76 can be 5 volts. The external image-capturing device 50 further includes a control unit 80 installed inside the housing 54 and electrically connected to the phone camera module 56, the strobe module 60, the second transmit port 66, the battery module 76, and the transformer 78 for controlling the external image-capturing device 50. The second transmit port 66 of the external image-capturing device 50 further includes a second signal port 82 for connecting the first signal port 72 of the mobile phone 52 to communicate with the mobile phone 52. The signal transmission between the first signal port 72 and the second signal port 82 can use an I2C or a UART interface. The second transmit port 66 further includes a second electric port 84 for connecting to the first electric port 74 of the mobile phone 52 and transmitting the electric power of the external image-capturing device 50 to the first electric port 74 of the mobile phone 52 to supply the operating electric power of the mobile phone 52.

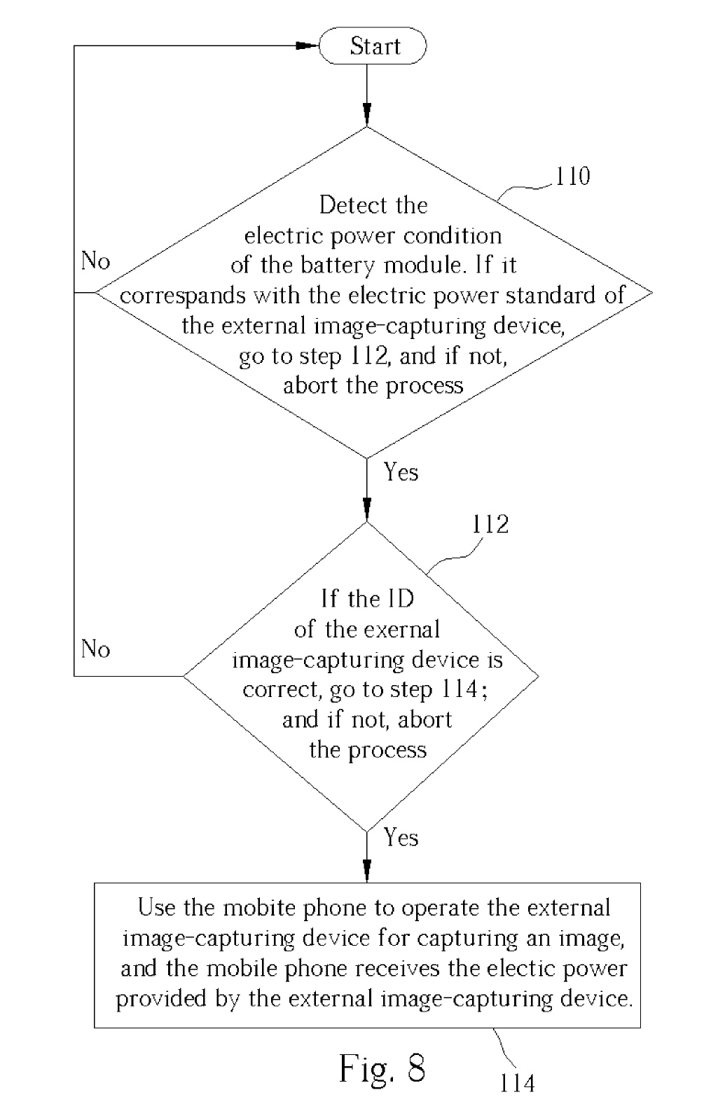

Please refer to FIG. 8. FIG. 8 contains a flowchart illustrating actions after the external image-capturing device 50 is connected to the mobile phone 52 of the second embodiment according to the present invention. The method includes:

Step 110: detect the electric power condition of the battery module 76 of the external image-capturing device 50. If the electric power condition corresponds with the electric power standard of the external image-capturing device 50, go to Step 112; and if not, abort the process;

Step 112: the mobile phone 52 obtains the ID of the external image-capturing device 50. If the ID of the external image-capturing device 50 is correct, go to Step 114; and

if not, abort the process; and

Step 114: use the mobile phone 52 to operate the external image-capturing device 50 for capturing an image, and the mobile phone 52 receives the electric power provided by the external image-capturing device 50.

The working principle of the second embodiment is similar to that of the first embodiment. After the external image-capturing device 50 is connected to the mobile phone 52, if the electric power condition of the battery 76 of the external image-capturing device 50 corresponds with the electric power standard of the external image-capturing device 50 such as the electric power quantity, the control unit 80 of the external image-capturing device 50 sends a corresponding signal to the first signal port 72 of the mobile phone 52 via the second signal port 82 to inform the phone control unit 70 that he electric power condition is correct. The mobile phone 52 also sends back an acknowledgment signal to the external image-capturing device 50. If the electric power condition does not correspond with the electric power standard of the image-capturing device 50, the image-capturing device 50 will abort the operating process.

If the electric power condition of the battery 76 of the external image-capturing device 50 corresponds with the electric power standard of the external image-capturing device 50, the control unit 80 of the external image-capturing device 50 will send the ID of the external image-capturing device 50 to the first signal port 72 via the second signal port 82 and then to the phone control unit 70 of the mobile phone 52. If the type specification of the external image-capturing device 50 is suitable for the mobile phone 52, the mobile phone 52 will send back an acknowledgment signal to the external image-capturing device 50. If not, the external image-capturing device 50 will not work. And then users can use the mobile phone 52 to operate the external image-capturing device 50 for capturing an image by the phone camera module 56 and providing light by the strobe module 60. And at the same time, the transformer 78 of the external image-capturing device 50 will transform the outputting voltage of the battery module 76 into the standard voltage of the mobile phone 52 and output the standard voltage of the mobile phone 52 to the first electric port 72 of the first transmit port 64 via the second electric port 84 of the second transmit port 66 for providing the operating electric power of the mobile phone 52. That is, when the external image-capturing device 50 is connected to the mobile phone 52 for capturing an image, the mobile phone 52 uses the electric power provided by the battery module 76 of the external image-capturing device 50 instead of the phone battery module 68. In addition, when the mobile phone 52 is connected to the external image-capturing device 50 and operates other functions, the battery module 76 of the external image-capturing device 50 also can provide the electric power for the mobile phone 52. Even when the mobile phone 52 is suspending or off, the battery module 76 can charge the phone battery module 68 of the mobile phone 52.

The control unit 80 of the external image-capturing device 50 can monitor the electric power condition of the battery module 76 of the external image-capturing device 50 anytime and send the electric power condition of the battery module 76 to the first signal port 72 via the second signal port 82 and then to the phone control unit 70 of the mobile phone 52. In this way, users can realize the remaining electric power quantity.

In the second embodiment, the present invention also can apply to the mobile phone including an internal phone camera if the external image-capturing device 50 does not include the phone camera module 56 and only provides the light-providing function of the strobe module 60. And the electric transmission model is the same as mentioned above. So the detailed description is omitted.

In contrast to the prior art, the present invention provides an external strobe device that can provide electric power to an image-capturing apparatus. So the present invention can provide another additional electric power source. Therefore the usage time and the battery life of the image-capturing apparatus can be increased. The present invention provides a good solution to the electric problem, especially for digital image-capturing devices.

Those skilled in the art will readily observe that numerous modifications and alterations of the device may be made while retaining the teachings of the invention. Accordingly, the above disclosure should be construed as limited only by the metes and bounds of the appended claims.

1. An external strobe device for connecting to an image-capturing apparatus, the image-capturing apparatus comprising a housing and a transmission module installed inside the housing, the external strobe device comprising:
a housing;
a strobe module installed inside the housing for providing light when the image-capturing apparatus captures an image;
a battery module installed inside the housing for supplying operating electric power of the strobe module;
a first electric port for connecting to the transmission module of the image-capturing apparatus and transmitting the electric power produced by the battery module to the transmission module to supply the operating electric power of the image-capturing apparatus; and
a transformer installed inside the housing and electrically connected to the battery module, the strobe module, and the first electric port for transforming an outputting voltage of the battery module into a standard voltage of the strobe module and outputting the standard voltage of the strobe module to the strobe module, and for transforming the outputting voltage of the battery module into the standard voltage of the image-capturing apparatus and outputting the standard voltage of the image-capturing apparatus to the image-capturing apparatus via the first electric port.

2. The external strobe device of claim 1 wherein the transmission module of the image-capturing apparatus comprises a second electric port for receiving the electric power transmitted from the first electric port to supply the operating electric power of the image-capturing apparatus, and a first signal port for transmitting signals to the external strobe device to operate the external strobe device.

3. The external strobe device of claim 2 further comprising a control unit installed inside the housing and electrically connected to the strobe module and the transformer for controlling the external strobe device, and a second signal port electrically connected to the control unit for connecting the first signal port and receiving signals from the image-capturing apparatus.

4. The external strobe device of claim 3 wherein the signal transmission between the first signal port and the second signal port utilizes an I2C interface.

5. The external strobe device of claim 3 wherein the signal transmission between the first signal port and the second signal port utilizes a UART interface.

6. The external strobe device of claim 3 wherein a driving signal can be transmitted from the first signal port to the second signal port for driving the strobe module to provide light.

7. The external strobe device of claim 3 wherein the electric quantity data of the battery module can be transmitted from the second signal port to the first signal port.

8. The external strobe device of claim 1 further comprising a power switch for turning on or turning off the external strobe device.

9. The external strobe device of claim 1 wherein the standard voltage of the image-capturing apparatus transformed from the outputting voltage of the battery module is 5 volts.

10. The external strobe device of claim 1 wherein the battery module contains a 3-volt Cr2 battery.

11. The external strobe device of claim 1 wherein the battery module contains two Ni-MH batteries.

12. The external strobe device of claim 1 wherein the battery module contains two Li-On batteries.

13. The external strobe device of claim 3 wherein the electric transmission between the first electric port and the second electric port utilizes a USB interface.

14. The external strobe device of claim 1 wherein the image-capturing apparatus further comprises a camera battery module installed inside the housing of the image-capturing apparatus for supplying the operating electric power of the image-capturing apparatus.

15. The external strobe device of claim 1 wherein the image-capturing apparatus is a digital camera.

16. The external strobe device of claim 1 wherein the image-capturing apparatus is a digital camcorder.

17. The external strobe device of claim 1 wherein the image-capturing apparatus is a storage device with an image-capturing function.

18. An external image-capturing device for connecting to a mobile phone, the mobile phone comprising a first electric port for receiving external electric power to supply operating electric power of the mobile phone and a first signal port for transmitting signals to the external image-capturing device to control the external image-capturing device, the external image-capturing device comprising:
a housing;
a phone camera module for capturing an image;
a strobe module installed inside the housing for providing light when the phone camera module captures an image;
a battery module installed inside the housing for supplying the operating electric power of the external image-capturing device;
a second electric port for connecting to the first electric port of the mobile phone and transmitting the electric power produced by the battery module to the first electric port of the mobile phone to supply the operating electric power of the mobile phone; and
a transformer installed inside the housing and electrically connected to the battery module, the phone camera module, the strobe module, and the second electric port for transforming an outputting voltage of the battery module into a standard voltage of the strobe module and outputting the standard voltage of the strobe module to the strobe module, transforming the outputting voltage of the battery module into the standard voltage of the phone camera module and outputting the standard voltage of the phone camera module to the phone camera module, and for transforming the outputting voltage of the battery module into the standard voltage of the mobile phone and outputting the standard voltage of the mobile phone to the mobile phone via the second electric port.

19. The external image-capturing device of claim 18 further comprising a control unit installed inside the housing and electrically connected to the strobe module, the phone camera module, and the transformer for controlling the external image-capturing device, and a second signal port electrically connected to the control unit for connecting the first signal port to communicate with the mobile phone.

20. The external image-capturing device of claim 18 wherein the signal transmission between the first signal port and the second signal port utilizes an I2C interface.

21. The external image-capturing device of claim 18 wherein the signal transmission between the first signal port and the second signal port utilizes a UART interface.

22. The external image-capturing device of claim 18 wherein the electric quantity data of the battery module can be transmitted from the second signal port to the first signal port.

23. The external image-capturing device of claim 18 wherein the battery module contains a 3-volt Cr2 battery.

24. The external image-capturing device of claim 18 wherein the battery module contains two Ni-MH batteries.

25. The external image-capturing device of claim 18 wherein the battery module contains two Li-On batteries.

26. The external image-capturing device of claim 18 wherein the mobile phone further comprises a phone battery module installed inside the housing of the mobile phone for supplying the operating electric power of the mobile phone.
